(19) United States
(12) Patent Application Publication
(10) Pub. No.: US 2017/0164086 A1
(43) Pub. Date: Jun. 8, 2017

(54) Headset with Stem Mounted Connector

(71) Applicant: Plantronics, Inc., Santa Cruz, CA (US)

(72) Inventor: Pierre Harper, Santa Cruz, CA (US)

(73) Assignee: Plantronics, Inc., Santa Cruz, CA (US)

(21) Appl. No.: 14/957,441

(22) Filed: Dec. 2, 2015

(51) Int. Cl. H04R 1/10; H04M 1/725; H04M 1/60; H04R 1/08

(52) U.S. Cl. CPC H04R 1/105; H04R 1/1041; H04R 1/1016; H04R 1/08; H04M 1/7253; H04M 1/6066; H04R 2420/09; H04R 2420/05; H04R 2201/107

(57) ABSTRACT

Methods and apparatuses for head-worn devices are disclosed. In one example, a head-worn device includes a primary housing and an earbud speaker. The head-worn device further includes a stem secondary housing containing a data connection interface, the stem secondary housing located between the primary housing and the earbud speaker.

### BACKGROUND OF THE INVENTION

Design of headsets presents unique challenges. Competing considerations must be addressed due to their small form factor. For example, users desire the headset to have a minimal size so as to be inconspicuous when worn. On the other hand, users wish their headset to have a maximal battery life. Furthermore, modern headsets offer increased functionality. Such increased functionality requires multiple user interfaces and components. However, the smaller headset form factor provides limited exterior surface area for placement of user interfaces and limited interior volume for placement of components. As a result, improved apparatuses and methods for headsets are needed.

### BRIEF DESCRIPTION OF THE DRAWINGS

The present invention will be readily understood by the following detailed description in conjunction with the accompanying drawings, wherein like reference numerals designate like structural elements.

FIG. 1A illustrates a left side view of a headset in one example of the invention.

FIG. 1B illustrates an exterior perspective view of the headset shown in FIG. 1A.

FIG. 1C illustrates a right side exterior view of the headset shown in FIG. 1A.

FIG. 1D illustrates a top side exterior view of the headset shown in FIG. 1A.

FIG. 2 illustrates a simplified block diagram of the headset shown in FIGS. 1A-1D.

FIG. 3 illustrates a side exterior view of a prior art headset.

### DESCRIPTION OF SPECIFIC EMBODIMENTS

Methods and apparatuses for headsets are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

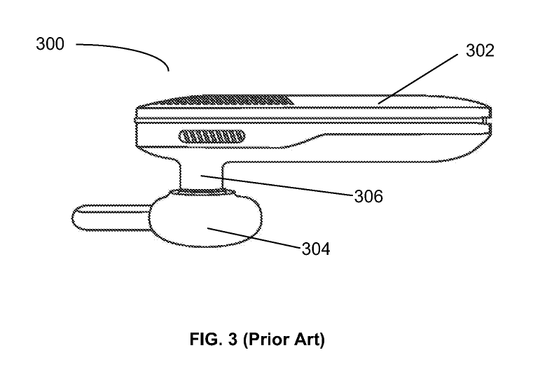

FIG. 3 illustrates a side exterior view of a prior art headset 300. Headset 300 includes a housing 302 and an earbud speaker, which may be covered with an ear cushion 304. The headset 300 includes a stem 306 located between the housing 302 and the earbud speaker. Stem 306 is an elongated narrow cylindrical shaped structure and functions to allow insertion of earbud speaker into a user ear.

The inventor has recognized several problems with the design of headset 300. The size of housing 302 (and therefore, headset 300) is largely dictated by the desired battery size as well as the required components of headset 300 which must be placed in housing 302. Housing 302 may include a wired connector interface, such as a micro-USB port, with the connector port somewhere on the exterior surface of housing 302. The presence of components such as the connector interface in housing 302 limit the size of the battery which can be used and limit the number or placement options of user interface inputs or outputs on the exterior surface of housing 302. If the designer wishes to increase the battery size or user interface options, he must increase the size of housing 302.

In one example of the invention, the inventor addresses the problems of the prior art by redesigning the speaker stem and relocating components such as a connector interface and its associated port to the speaker stem. Advantageously, by moving the connector interface to the speaker stem, room is made for a larger capacity battery for an existing size configuration. Alternatively, the same battery can be used in a smaller form factor.

Furthermore, movement of the connector interface to the speaker stem frees space on the exterior surface of housing 302 which can be used for an additional user interface input or output. For example, the connector interface port can be replaced with an additional dedicated button for Siri, a mute function, a call answer/end button, etc. Redesign of the speaker stem and relocation of the connector interface has a minimal impact on headset ergonomics. In one example embodiment, the size of housing 302 is reduced from a length of 49.5 mm, width of 16.8 mm, and height of 9.4 mm to a length of 45.5 mm, width of 14 mm, and height of 8.9 mm while still accommodating the same size battery.

In one example of the invention, a head-worn device includes a primary housing and an earbud speaker. For example, the head-worn device is a headset. The head-worn device further includes a stem secondary housing containing a data connection interface, the stem secondary housing located between the primary housing and the earbud speaker. In one example, the stem secondary housing is elongated and arranged to allow insertion of the earbud speaker into a user ear. The stem secondary housing is perpendicular to a planar surface of the primary housing. In one example, the stem secondary housing has a planar surface on which the data connection interface is exposed. In one example, the data connection interface is a mini-USB interface. In one example, the head-worn device further includes a wireless communications transceiver, a processor, a microphone, and a battery disposed within the primary housing. The head-worn device further includes one or more user interfaces disposed on an exterior surface of the primary housing.

In one example, a head-worn device includes a primary housing and a stem extending from the primary housing and arranged as a secondary housing containing a data connection interface. The head-worn device includes an earbud coupled to the stem, the earbud comprising a speaker. The head-worn device further includes radio transceiver disposed within the primary housing, a processor disposed within the primary housing, a microphone disposed within the primary housing, and a battery disposed within the primary housing. The head-worn device further includes one or more user interfaces disposed on an exterior surface of the primary housing. For example, the head-worn device is a headset.

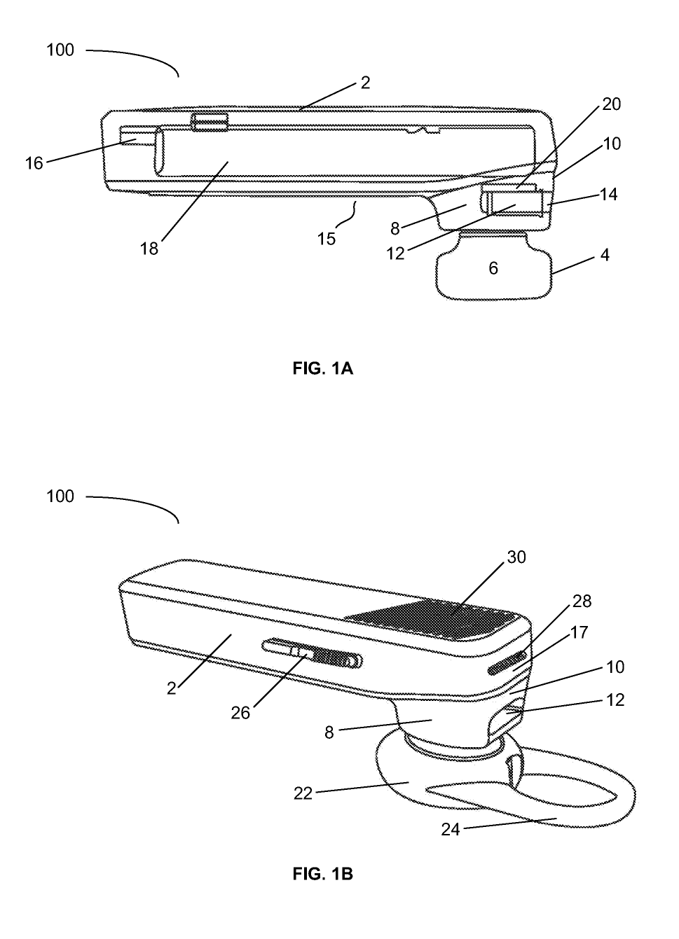

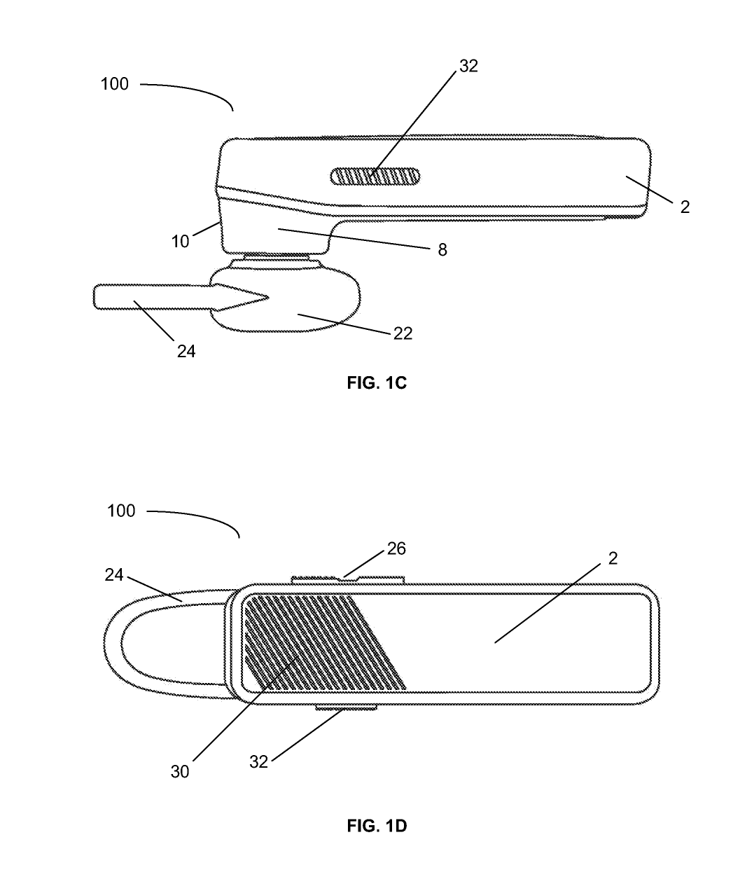

FIG. 1A illustrates a simplified left side view of a headset 100 showing internal components in one example of the invention. Headset 100 includes a primary housing 2 and a stem 8 extending from the primary housing 2. Stem 8 is arranged as a secondary housing containing a connector interface 12. In one example, the primary housing 2 is substantially rectangular. Various device components can be placed in primary housing 2 or on the exterior surface of primary housing 2. For example, device components may include antennas, microphones, buttons, displays, indicators, a battery, and related circuitry, processors, and controllers.

Connector interface 12 includes a port 14 accessible on the exterior surface of the stem 8. The headset 100 includes an earbud 4 coupled to the stem 8, the earbud 4 having a speaker 6. The headset 100 further includes radio transceiver disposed within the primary housing 2, a processor disposed within the primary housing 2, a microphone 16 disposed within the primary housing 2, and a battery 18 disposed within the primary housing 2. The headset 100 further includes one or more user interfaces disposed on an exterior surface of the primary housing 2. In one example, the radio transceiver is a Bluetooth radio transceiver. Earbud 4 is arranged for insertion into the wearer's ear so that it supports the primary housing 2 proximate the wearer's head.

In one example, connector interface 12 is a mini-USB (USB Mini-A or USB Mini-B) connector component which mates with a corresponding connector component. In further examples, connector interface 12 may be any wired interface capable of signal transfer. For example, connector interface 12 may utilize a Firewire (IEEE 1394), USB A, USB B, a 2.5 mm jack, or a serial interface. Micro-USB connectors may be used or other types of plug and receptacle connectors. Connector interface 12 is utilized for transferring data to and from headset 100. Connector interface 12 connects to a corresponding connector in a dock or cable to connect to a data source for data download or upload. Connector interface 12 is operable to receive a charging power for the battery 18 disposed within the primary housing 2.

Stem 8 is elongated and arranged to allow insertion of the earbud speaker 6 into a user ear. Stem 8 is perpendicular to a bottom surface 15 of the primary housing 2.

In one example, the stem 8 is hollow and integrated with the primary housing 2. In one example, the stem 8 includes a planar surface 10 on which the connector interface 12 is exposed. Stem 8 is advantageously designed to have a planar surface to accommodate a connector interface such as a mini-USB connector so that the connector port is flush on the planar surface. In one example, the planar surface 10 of the stem 8 on which the connector interface 12 is exposed is square or rectangular in shape. In one example, the hollow interior cross section of stem 8 is square or rectangular.

In one example, the stem 8 further accommodates a printed circuit board 20 associated with the connector interface 12 as well as electrical wires to couple components disposed in primary housing 2 and earbud 4. Advantageously, connector interface 12 is placed in stem 8 to preserve all of the surfaces of primary housing 2 for use with user interfaces more commonly used when the headset 100 is being worn, as these surfaces are most intuitively accessible.

In one example, primary housing 2 is a longitudinal rectangular or tubular member. Earbud 4 perpendicularly protrudes away from one end of primary housing 2, where primary housing 2 includes microphone 16 disposed at the opposite end.

FIG. 1B illustrates an exterior perspective view of the headset 100 shown in FIG. 1A. In this illustration, headset 100 includes an ear cushion 22 disposed over the earbud 4, where the ear cushion 22 includes a concha stabilizer 24. Disposed on exterior surfaces of the primary housing 2 are user interface input 26, user interface input 28, and user interface input 30. Primary housing 2 includes an end surface 17 defined by a width and a height of the primary housing 2, and wherein the user interface input 28 is disposed on the end surface 17. In one example, user interface input 28 is a call/answer/end (CAE) button. Placement of this frequently used function on end surface 17 is ideal as it is easily and intuitively accessed when the headset is being worn. For example, placement in this position reduces the possibility of accidental activation, and avoids putting pressure directly into the ear canal when it is depressed as is the case if it is placed on the top of the headset.

As shown in this example, user interface input 26 may be a rocker switch, and user interface input 28 and user interface input 30 may be depressible buttons. FIG. 1C illustrates a right side exterior view of the headset 100 shown in FIG. 1A. Illustrated in FIG. 1C is an additional user interface input 32, shown as a depressible button. FIG. 1D illustrates a top exterior view of the headset 100 shown in FIG. 1A.

Primary housing 2 and earbud 4 may be formed by one or more members. In one example, primary housing 2 is a single unit and is formed via an extrusion or related process. Stem 8 can be a portion of primary housing 2, earbud 4, or a separate distinct piece that is attached there between. Any suitable means can be used to attach primary housing 2, earbud 4, and stem 8 together, including but not limited to glues, epoxies, screws, clips, and brackets. In one example, stem 8 includes a threaded interior surface which mates with a corresponding engaging surface on earbud 4. Other mechanisms such as tabs, slots, or notches may be utilized to couple earbud 4 and stem 8.

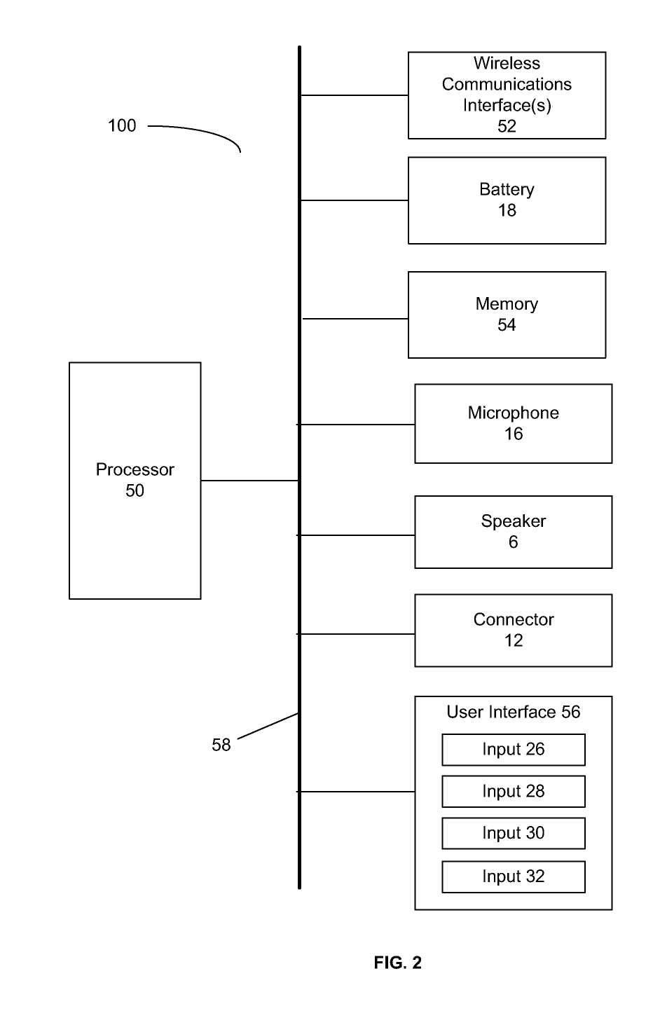

FIG. 2 illustrates a simplified block diagram of the headset 100 shown in FIGS. 1A-1D. Headset 100 includes a processor 50 operably coupled to wireless communications interface(s) 52, battery 18, memory 54, microphone 16, speaker 6, connector interface 12, and user interface 56.

Headset 100 includes communication interface(s) 52, one or more of which may utilize a transceiver and an antenna. The communications interface(s) 52 may also include other processing means, such as a digital signal processor and local oscillators. In one example, communications interface(s) 52 include one or more short-range wireless communications subsystems which provide communication between headset 100 and different systems or devices. For example, the short-range communications subsystem may include an infrared device and associated circuit components for short-range communication, a near field communications (NFC) subsystem, a Bluetooth subsystem including a transceiver, or a Wi-Fi subsystem. Interconnect 58 may communicate information between the various components of headset 100.

Communication interface(s) 52 may provide access to a network, such as a local area network. Communication interface(s) 52 may include, for example, a wireless network interface having antenna. In one embodiment, communication interface(s) 52 may provide access to a local area network, for example, by conforming to IEEE 802.11b and/or IEEE 802.11 g standards, and/or the wireless network interface may provide access to a personal area network, for example, by conforming to Bluetooth standards. In addition to, or instead of, communication via wireless LAN standards, communication interface(s) 52 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol. The specific design and implementation of the communications interfaces of the headset 100 is are dependent upon the communication networks in which the device is intended to operate.

Processor 50 allows for processing data, in particular managing data between connector interface 12, memory 54, microphone 16, and speaker 6. Microphone 16 is operable to receive a user voice input or other audio. Headset 100 includes general operational firmware. In one example, processor 50 is a high performance, highly integrated, and highly flexible system-on-chip (SOC). Processor 50 is configured to execute code in memory 54.

Memory 54 may include a variety of memories, and in one example includes SDRAM, ROM, flash memory, or a combination thereof. Memory 54 may further include separate memory structures or a single integrated memory structure. In one example, memory 54 may be used to store passwords, network and telecommunications programs, and/or an operating system (OS).

While only a single processor 50 is shown, headset 100 may include multiple processors and/or co-processors, or one or more processors having multiple cores. The processor 50 and memory 54 may be provided on a single application-specific integrated circuit, or the processor 50 and the memory 54 may be provided in separate integrated circuits or other circuits configured to provide functionality for executing program instructions and storing program instructions and other data, respectively. Memory 54 also may be used to store temporary variables or other intermediate information during execution of instructions by processor 50. Headset 100 may include operating system code and specific applications code, which may be stored in non-volatile memory. For example the code may include drivers for the headset 100 and code for managing the drivers and a protocol stack for communicating with the communications interface(s) 52.

User interface 56 allows for communication between the headset user and the headset, and in one example includes an audio and/or visual interface such that a prompt may be provided to the user's ear and/or an LED may be lit. In one example, user interface 56 includes user interface input 26, user interface input 28, user interface input 30, and user interface input 32. Generally, user interface 56 may include buttons, switches, or touch sensors to receive call initiate, call answer, power on/off, menu navigation, or multimedia output control user input actions and user preferences. User interface 56 may include one or more display devices, such as an LCD screen.

While the exemplary embodiments of the present invention are described and illustrated herein, it will be appreciated that they are merely illustrative and that modifications can be made to these embodiments without departing from the spirit and scope of the invention. For example, methods, techniques, and apparatuses described as applying to one embodiment or example may also be utilized with other embodiments or examples described herein. Thus, the scope of the invention is intended to be defined only in terms of the following claims as may be amended, with each claim being expressly incorporated into this Description of Specific Embodiments as an embodiment of the invention.

What is claimed is:

1. A head-worn device comprising:
a primary housing;
a stem extending from the primary housing and arranged as a secondary housing containing a data connection interface;
an earbud coupled to the stem, the earbud comprising a speaker;
a wireless communications transceiver disposed within the primary housing;
a processor disposed within the primary housing;
a microphone disposed within the primary housing;
a battery disposed within the primary housing; and
one or more user interfaces disposed on an exterior surface of the primary housing.

2. The head-worn device of claim 1, wherein the primary housing is rectangular.

3. The head-worn device of claim 1, further comprising an ear cushion disposed over the earbud.

4. The head-worn device of claim 1, wherein the stem further contains a printed circuit board associated with the data connection interface.

5. The head-worn device of claim 1, wherein the data connection interface comprises components of a mini-USB interface.

6. The head-worn device of claim 1, wherein the data connection interface is operable to receive a charging power for the battery disposed within the primary housing.

7. The head-worn device of claim 1, wherein the wireless communications transceiver comprises a Bluetooth radio transceiver.

8. The head-worn device of claim 1, wherein the stem comprises a planar surface on which the data connection interface is exposed.

9. The head-worn device of claim 8, wherein the planar surface of the stem on which the data connection interface is exposed is square or rectangular.

10. The head-worn device of claim 1, wherein the stem has a square or rectangular cross section.

11. The head-worn device of claim 1, wherein the stem is perpendicular to a planar surface of the primary housing.

12. The head-worn device of claim 1, wherein the stem is integrated with the primary housing.

13. The head-worn device of claim 1, wherein the primary housing comprises an end surface defined by a width and a height of the primary housing, and wherein a user interface input button is disposed on the end surface.

14. A head-worn device comprising:
a primary housing;
an earbud speaker; and
a stem secondary housing containing a data connection interface, the stem secondary housing located between the primary housing and the earbud speaker.

15. The head-worn device of claim 14, wherein the stem secondary housing is elongated and arranged to allow insertion of the earbud speaker into a user ear.

16. The head-worn device of claim 14, further comprising:
a wireless communications transceiver disposed within the primary housing;
a processor disposed within the primary housing;
a microphone disposed within the primary housing;
a battery disposed within the primary housing; and
one or more user interfaces disposed on an exterior surface of the primary housing.

17. The head-worn device of claim 14, wherein the primary housing is rectangular.

18. The head-worn device of claim 14, wherein the stem secondary housing further contains a printed circuit board associated with the data connection interface.

19. The head-worn device of claim 14, wherein the data connection interface comprises a mini-USB interface.

20. The head-worn device of claim 14, wherein the stem secondary housing comprises a planar surface on which the data connection interface is exposed.

21. The head-worn device of claim 20, wherein the planar surface of the stem secondary housing on which the data connection interface is exposed is square or rectangular.

22. The head-worn device of claim 14, wherein the stem secondary housing has a square or rectangular cross section.

23. The head-worn device of claim 14, wherein the stem secondary housing is perpendicular to a planar surface of the primary housing.

24. The head-worn device of claim 14, wherein the stem secondary housing is integrated with the primary housing.

25. The head-worn device of claim 14, wherein the primary housing comprises an end surface defined by a width and a height of the primary housing, and wherein a user interface input button is disposed on the end surface.
